(19) United States
(12) Patent Application Publication
(10) Pub. No.: US 2007/0025285 A1
(43) Pub. Date: Feb. 1, 2007

(54) Access burst and normal burst mix-mode support for GSM/GPRS compliant handsets

(76) Inventor: Weidong Li, Los Gatos, CA (US)

Correspondence Address: MCANDREWS HELD & MALLOY, LTD, 500 WEST MADISON STREET, SUITE 3400, CHICAGO, IL, 60661, US

(21) Appl. No.: 11/191,748

(22) Filed: Jul. 28, 2005

(51) Int. Cl. H04B 7/212

(52) U.S. Cl. 370/321; 370/337; 370/347; 370/442

(57) ABSTRACT

An access burst and normal burst mix-mode support for GSM/GPRS compliant handsets is provided and may comprise transmitting bursts of different data types within a single GSM frame by a single GSM device, wherein the data types may comprise access burst and normal burst. Transmit power may be ramped up prior to transmitting a first burst in the GSM frame for the single GSM device, and ramped down after transmitting a first burst in the GSM frame for the single GSM device. A plurality of ramp-up and ramp-down values may be stored for use in ramping up or ramping down the transmit power, respectively. The plurality of ramp-up and ramp-down values may be converted to an analog control signal that may be used to control the ramping up and ramping down of the transmit power, respectively.

### CROSS-REFERENCE TO RELATED APPLICATIONS/INCORPORATION BY REFERENCE

This application makes reference to: U.S. patent application Ser. No.______ (Attorney Docket Number 16423US01) filed Jul. 28, 2005.

The above stated application is hereby incorporated herein by reference in its entirety.

### FIELD OF THE INVENTION

Certain embodiments of the invention relate to wireless communication. More specifically, certain embodiments of the invention relate to an access burst and normal burst mix-mode support for GSM/GPRS compliant handsets.

### BACKGROUND OF THE INVENTION

The introduction of cellular communications systems in the late 1970's and early 1980's represented a significant advance in mobile communications. The networks of this period may be commonly known as first generation, or “1 G,” systems. These systems were based upon analog, circuit-switching technology. The most prominent of these systems may have been the advanced mobile phone system (AMPS). Second generation, or “2 G,” systems ushered in performance improvements over 1 G systems and introduced digital technology to mobile communications. Exemplary 2 G systems include the global system for mobile communications (GSM), digital AMPS (D-AMPS), and code division multiple access (CDMA). GSM, which became the dominant standard for 2 G systems, uses Gaussian minimum shift keying (GMSK) modulation format. The GMSK modulation is a binary modulation scheme of one bit per symbol. Some advantages of the GMSK format are compact output power spectrum and high immunity to noise and interference.

GSM uses time division multiple access (TDMA) technology that allows multiple GSM devices to time-share each 200 kilohertz (KHz) radio frequency (RF) channel. Each channel is then divided according to time using a TDMA scheme. Each of the carrier frequencies is divided into a 120 ms multiframe. A multiframe is made up of 26 frames. Two of these frames are used for control purposes, while the remaining 24 frames are used for traffic. Each can in turn be divided into 8 bursts, and each of the 8 bursts is assigned to a single GSM device. In a TDMA system, a burst is the unit of time, and each burst lasts for approximately 0.577 ms. Therefore, the frame has a corresponding duration of 4.615 ms. Corresponding channel capacity using GMSK modulation is 148 bits per time slot. In voice mode, the GSM device is always assigned one slot per frame for transmission of voice data. Similarly, a form of wireless data service called circuit-switched data allots a time slot in each frame to a GSM device whether there is data present or not. Circuit-switched operation is inherently inefficient because a slot is always assigned whether or not the mobile phone has any information to send. Additionally, in order to reduce power usage and interference to other GSM devices, a GSM device ramps up power to transmit and then ramps down power after the transmission period for the slot. However, when the GSM device transmits during its time slot when there is no information to send, power may be wasted and additional interference may occur.

General packet radio service (GPRS), which is an example of a 2.5 G network service oriented for data communications, comprises enhancements to GSM that require additional hardware and software elements in existing GSM network infrastructures. Although GPRS also uses GMSK modulation, where GSM may only allot one time slot in a time division multiple access (TDMA) frame, GPRS may allot up to eight time slots in a TDMA frame, thereby providing a data transfer rate of up to 115.2 kbits/s. GPRS is simply an extension of the GSM standard to provide packet data services. Another 2.5 G network, enhanced data rates for GSM evolution (EDGE), also comprises enhancements to GSM, and like GPRS, EDGE may allocate up to 8 time slots in a TDMA frame for packet-switched, or packet mode, transfers. However, unlike GPRS and GSM, EDGE uses 8 phase shift keying (8PSK) modulation to achieve data transfer rates that may be as high as 384 kbits/s.

With 8PSK modulation, there are eight distinct phase changes that a decoder may detect in the binary data. With every phase transition, the symbols may rotate an additional 67.5°, causing a shift of the I/Q constellation relative to its previous starting position. Although the 3 bits/symbol feature of the 8PSK modulation format may provide high data rates, it is inherently prone to errors in the air interface due to the fast changing phase profile of the RF signal.

The GSM communication system allows the mobile device to transmit multiple slots within a frame as directed by the network. This permits a system operator to take advantage of dead air time associated with circuit-switched networks to increase capacity and data rates. For example, a mobile device in some systems may transmit a multiburst of up to four bursts in a frame. Generally, all the bursts in the multiburst may be normal bursts. Normal bursts may carry information, such as voice, data, or signaling. However, on occasion, a GSM device may need to send access bursts. Access bursts may be used by the receiving base station to calculate the signal propagation delay from the mobile GSM device to the base station. The receiving base station may then indicate to the GSM device when, relative to the received signal, it needs to transmit the bursts. This may be necessary since the bursts sent by the mobile GSM device may need to be received in a specific time window in order not to interfere with transmissions from other mobile GSM devices.

Generally, a receiving base station may keep track of the GSM device with the received normal bursts. However, access bursts may be necessary when a receiving base station does not have valid propagation delay for the GSM device. This may occur when the GSM device first comes in range of the base station, when it is turned on, or when it is handed off to another base station. An access burst may have a limited number of bits that is sent in order to ensure that the calibrating bits in the burst will not interfere with other bursts from other GSM devices. The size of the access burst may be set to allow a maximum distance of 35 kilometers between the GSM device and the receiving base station. However, the GSM device may not support transmission of normal burst and access burst in the same multiburst. This may lead to inefficiency since, for example, the GSM device may have to wait until the transmissions of the present multiburst of normal bursts is finished before sending access bursts.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for access burst and normal burst mix-mode support for GSM/GPRS compliant handsets, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a diagram illustrating exemplary GSM multiframe, which may be utilized in connection with an embodiment of the invention.

FIG. 1b is a diagram illustrating exemplary normal data burst and access burst in different GSM frames, which may be utilized in connection with an embodiment of the invention.

FIG. 1c is a diagram illustrating exemplary normal data burst and access burst in the same GSM frame, in accordance with an embodiment of the invention.

FIG. 1d is a block diagram of exemplary transmitter system of a GSM device, which may be utilized in connection with an embodiment of the invention.

FIG. 2a is a block diagram of exemplary transmission path, in accordance with an embodiment of the invention.

FIG. 2b is a block diagram of exemplary buffer for storing access burst data and normal burst data, in accordance with an embodiment of the invention.

FIG. 3a is a timing diagram of a multiburst transmission, in accordance with an embodiment of the invention.

FIG. 3b is a timing diagram of power ramp-up and ramp-down during transmission, in accordance with an embodiment of the invention

FIG. 4 is a block diagram illustrating exemplary event generator, in accordance with an embodiment of the invention.

FIG. 5 is a block diagram illustrating an automatic power control block, in accordance with an embodiment of the invention.

FIG. 6 is a flow diagram illustrating exemplary routine for access burst and normal burst mix-mode support, in accordance with an embodiment of the invention.

### DETAILED DESCRIPTION OF THE INVENTION

Certain embodiments of the invention may be found in a method for access burst and normal burst mix-mode support for GSM/GPRS compliant handsets. Aspects of the method may comprise transmitting bursts of different data types within a single GSM frame by a single GSM device, wherein the data types may comprise access burst data type and normal burst data type.

Transmit power may be ramped up prior to transmitting a first burst in the GSM frame for the single GSM device. A plurality of ramp-up values may be stored for use in ramping up the transmit power and these values may be converted to an analog control signal that may be used to control the ramping up transmit power.

Similarly, transmit power may be ramped down after transmitting a last burst in the GSM frame for the single GSM device. A plurality of ramp-down values may be stored for use in ramping down the transmit power. The plurality of ramp-down values may be converted to an analog control signal that may be used to control the ramping down transmit power. Data that is to be transmitted may be stored in memory, and the data may be transmitted within a single GSM frame by the single GSM device. A portion of the stored data may be selected for an initialization portion of the burst and another portion of the stored data may be selected for a data portion of said burst.

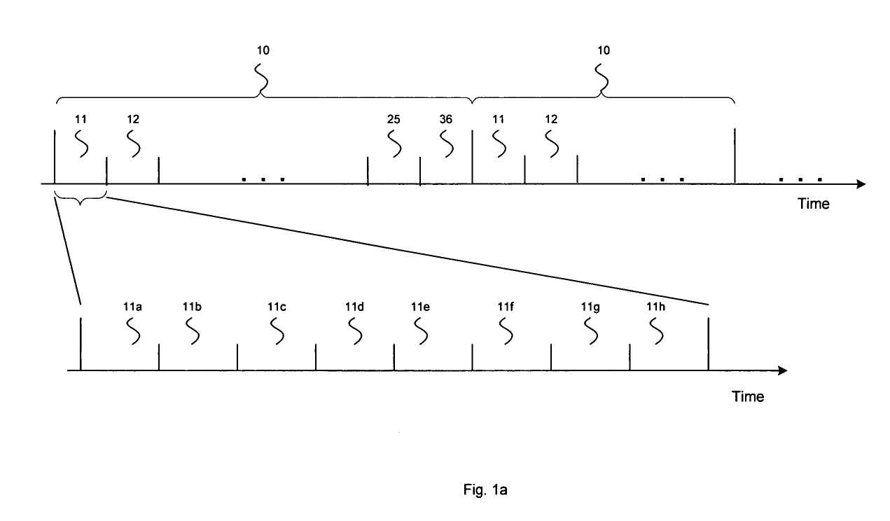

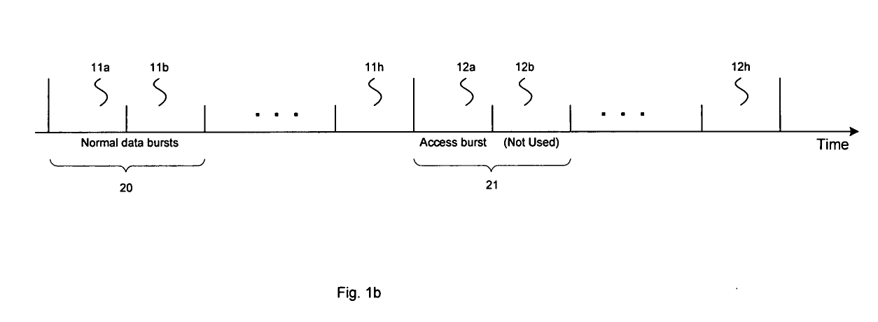

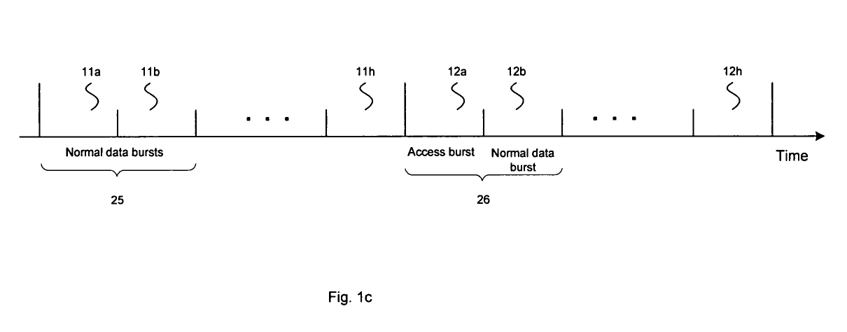

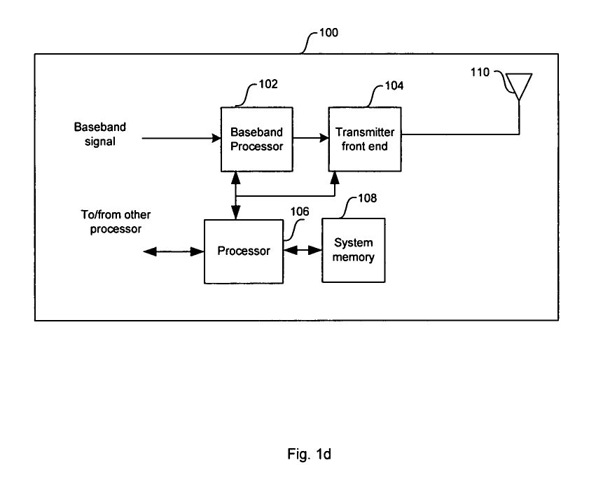

A GSM/GPRS system may be used to communicate voice information and data information. GSM/GPRS systems may transmit voce/data information in 200 KHz channels, and each channel may be time-multiplexed among various GSM devices. The time multiplexing may be illustrated in FIG. 1a. FIG. 1a is a diagram illustrating exemplary GSM multiframe, which may be utilized in connection with an embodiment of the invention. Referring to FIG. 1a, there is shown a plurality of multiframes 10, where each multiframe may comprise twenty-six frames 11, . . . , 36. Two of these frames may be used for control and twenty-four frames may be used for user data communication. Each frame may comprise 8 bursts (or slots) a, b, . . . , h. The burst a in frame 11 may be referred to as burst 11 a, and similarly the other seven bursts may be referred to as 11b, . . . , 11h.

A different GSM device may be assigned to each of the 8 different bursts a, b, . . . , h in a frame for voice communication. For example, a GSM device A may be assigned to a first burst in each frame and, hence, may send voice data in burst 11a, then 12a, etc. A GSM device B may be assigned to a second burst in each frame and, hence, may send voice data in burst 11b, then 12b, etc. This may repeat for other multiframes for as long a period of time as the GSM device keeps the voice channel open. The bursts comprising normal user data may be referred to as normal data bursts. Occasionally, the GSM/GPRS system may require access bursts in order to determine the time-delay from the GSM device to a base station. The GSM device may then transmit an access burst in place of a normal data burst in a frame.

When a GSM device requests a data channel, the GSM/GPRS system may allocate a number of sequential bursts, as the bursts may be available. This may be illustrated in FIG. 1b. FIG. 1b is a diagram illustrating exemplary normal data burst and access burst in different GSM frames, which may be utilized in connection with an embodiment of the invention. Referring to FIG. 1b, there is shown the bursts a, . . . , h in frames 11 and 12. Two bursts in each of the frames 11 and 12, for example, the bursts 11a and 11b, and 12a and 12b, may be part of a multibursts 20 and 21, respectively, that may be assigned to the GSM device A to transmit data. The GSM device A may also be requested by the GMS/GPRS system to send an access burst. Accordingly, the GSM device A may transmit normal data bursts on the bursts 11a and 11b of the multiburst 20, and an access burst in the next frame 12a of the multiburst 21. The burst 12b of the multiburst 21 may be unused.

However, an embodiment of the invention may utilize all frames assigned to a GSM device by being able to send the normal data burst and access burst within the same frame. FIG. 1c illustrates this embodiment. FIG. 1c is a diagram illustrating exemplary normal data burst and access burst in the same GSM frame, in accordance with an embodiment of the invention. Referring to FIG. 1c, a single GSM device may transmit normal data bursts in bursts 11a and 11b of the multiburst 25, and an access burst in frame 12a and a normal data burst in frame 12b in the multiburst 26. In this manner, bursts assigned to a single GSM device may be used efficiently.

FIG. 1d is a block diagram of exemplary transmitter system of a GSM device, which may be utilized in connection with an embodiment of the invention. Referring to FIG. 1d, the GSM device 100 may comprise a baseband processor 102, a transmitter front end 104, a processor 106, and a memory block 108. The baseband processor 102 may comprise suitable logic, circuitry, and/or code that may be adapted to process baseband signals and to communicate processed baseband signals to the transmitter front end 104. The processing may comprise digital filtering and/or modulation using the appropriate modulation scheme, such as, for example, GMSK, and converting the baseband signal to an analog signal. The transmitter front end 104 may comprise suitable logic, circuitry, and/or code that may be adapted to, for example, amplify the processed baseband signals. The amplified signal may be communicated to an antenna for transmission.

The processor 106 may comprise suitable logic, circuitry, and/or code that may be adapted to control the operations of the transmitter front end 104 and/or the baseband processor 102. For example, the processor 106 may be utilized to update and/or modify programmable parameters and/or values in a plurality of components, devices, and/or processing elements in the transmitter front end 104 and/or the baseband processor 102. Control and/or data information may be transferred from at least one processor external to the GSM device 100 to the processor 106. Similarly, the processor 106 may transfer control and/or data information to at least one controller and/or processor external to the GSM device 100.

The processor 106 may utilize the received control and/or data information to determine the mode of operation of the transmitter front end 104. For example, the processor 106 may read and/or write data and/or status information to various registers in the baseband processor 102 and/or transmitter front end 104. In this manner, the data for the bursts that may be transmitted as a multiburst, and the order in which the data may be transmitted may be determined. The memory block 108 may comprise suitable logic, circuitry, and/or code that may be adapted to store a plurality of control, status and/or data information. The information stored in memory block 108 may be transferred to the transmitter front end 104 from the memory block 108 via the processor 106.

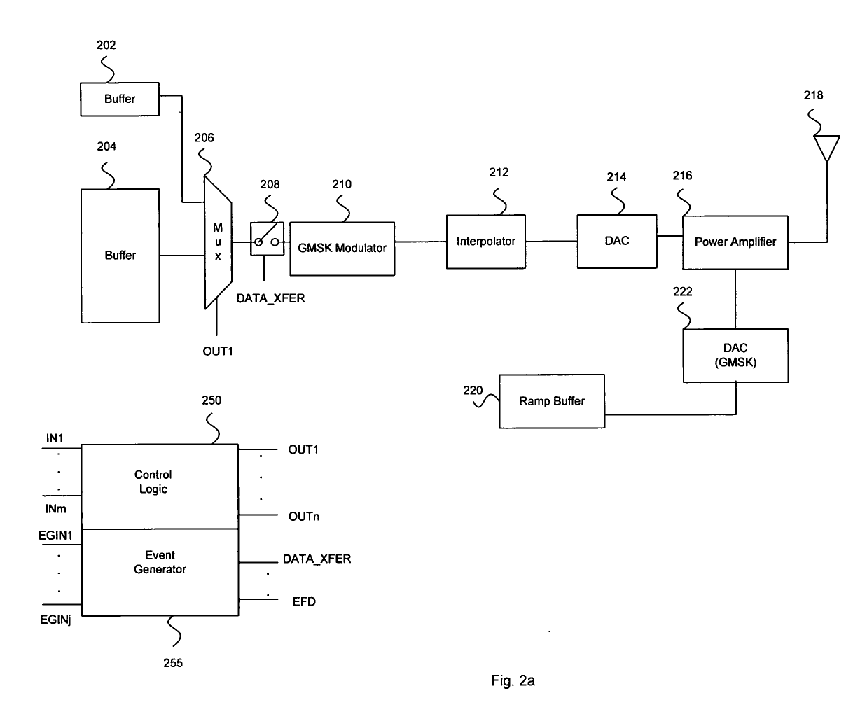

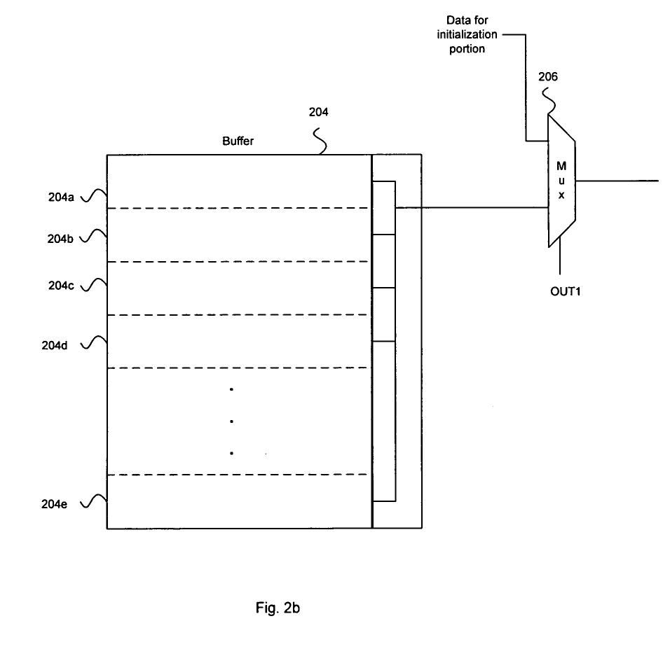

FIG. 2a is a block diagram of exemplary transmission path, in accordance with an embodiment of the invention. Referring to FIG. 2a, there is shown buffers 202, 204, and 220, multiplexer 206, switch 208, modulator 210, interpolator 212, digital to analog converters (DACs) 214 and 222, power amplifier 216, an antenna 218, control logic 250, and event generator 255.

Outputs of the buffers 202 and 204 may be coupled to the inputs of the multiplexer 206. An output of the multiplexer 206 may be coupled to a first terminal of the switch 208, and a second terminal of the switch 208 may be coupled to an input of the modulator 210. An output of the modulator 210 may be coupled to an input of the interpolator 212, and an output of the interpolator 212 may be coupled to an input of the DAC 214. An output of the DAC 214 may be coupled to an input of the power amplifier 216, and an output of the power amplifier 216 may be coupled to the antenna 218. Output of the buffer 220 may be coupled to an input of the DAC 222. An output of the DAC 226 may be coupled to a control input of the power amplifier 216.

The buffers 202 and 204, and 220 may comprise suitable circuitry and/or logic that may be adapted to store data. For example, the processor 106 may store data that may be transmitted into the buffer 204. The processor 106 may store ones in the buffer 202 for transmission during an initialization portion of the burst before the data from the buffer 204 may be transmitted. Similarly, the processor 106 may store data in the buffer 220 that may be used to ramp up and ramp down a power level of the power amplifier 216.

The multiplexer 206 may comprise suitable circuitry and/or logic that may be adapted to transfer one of a plurality of inputs to an output. The multiplexer 206 may have as inputs data from the buffers 202 and 204. At least one signal, for example, a control signal OUT1 from the control logic 250, may indicate whether to transfer data from the buffer 202 or from the buffer 204 to the output. At least one control signal, for example, a control signal DATA_XFER, may be communicated from the event generator 255 to the switch 208 to indicate whether the switch 208 should be open or closed.

The modulator 210 may comprise suitable circuitry, logic and/or code that may be adapted to digitally process a baseband signal. For example, the modulator 210 may process digital signals from the multiplexer 206 for GMSK modulation. The interpolator 212 may comprise suitable circuitry, logic and/or code that may be adapted to digitally process a signal to enhance the signal. For example, the interpolator 212 may digitally filter an input signal, for example, from the modulator 210, in order to attenuate unwanted signal components.

The DACs 214 and 222 may comprise suitable circuitry and/or logic that may be adapted to convert digital signal to analog signal. For example, the DAC 214 may receive digital data from the interpolator 212 and communicate analog data to the power amplifier 216. The DAC 222 may receive digital data from the buffer 220 and convert the digital data to an analog signal that may control the gain of the power amplifier 216.

The power amplifier 216 may comprise suitable circuitry and/or logic that may be adapted to amplify an input signal. The amplification of the signal from the DAC 214 may be determined by a control signal from, for example, the DAC 216. The antenna 218 may receive an analog signal from the power amplifier 216 and transmit it.

The control logic 250 may comprise suitable logic and/or circuitry that may be adapted to provide output signals, for example, the output signals OUT1, . . . , OUTn. The output signals OUT1, . . . , OUTn may be generated from input signals, for example, input signals IN1, . . . , INm, where at least one of the input signals may be a clock signal. The output signal OUT1 may, for example, be communicated to the multiplexer 206 and may be used to control data transferred to the output. The control logic 250 may also interface to a processor and/or memory, for example, the processor 106 (FIG. 1d) and/or memory block 108 (FIG. 1d). Accordingly, data and/or commands may be communicated to the control logic 250, and status and/or data may be communicated to the processor 106 (FIG. 1d) and/or the memory block 108 (FIG. 1d).

The event generator 255 may comprise suitable logic and/or circuitry that may be adapted to provide output signals, for example, the output signals data transfer signal DATA_XFER, transmit calibration enable signal TXCALEN, transmit DAC clock enable signal TDACCKEN, ramp-up/ramp-down signal ERUB, and enable fetch data signal EFD. The output signals may be generated from input signals, for example, input signals EGIN1, . . . , EGINj, where at least one of the input signals may be a clock signal.

The transmit calibration enable signal TXCALEN may be utilized to calibrate a DAC, for example, the DAC 214, as needed before each multiburst. The data transfer signal DATA_XFER may be used to open or close the switch 208. The transmit DAC clock enable signal TDACCKEN may be utilized in enabling a clock signal for a DAC, for example, the DAC 214, during transmission, and disabling the clock signal when the DAC 214 is not transmitting. Accordingly, the DAC 214 may utilize less power when it is not transmitting. The ramp-up/ramp-down signal ERUB may be utilized in ramping up and down the transmission power levels for the multibursts. The enable fetch data signal EFD may be utilized in fetching data, for example, from the buffers 202 and 204, for transmission in the multibursts.

In operation, an output of the multiplexer 206 may be selected, and the switch 208 may be closed by a control signal OUT1 generated by the control logic 250. The inputs to the multiplexer 206 may be derived from the buffers 202 and 204. The data in the buffer 202 may be data that may be, for example, used for an initialization portion of the burst. The data in the buffer 204 may be data that is to be transmitted in a data portion of the burst. The data in the buffer 204 may be communicated to the modulator 210 via the multiplexer 206. If the modulator 210 is not used, for example, when there is no transmission of data, the modulator 210 may be powered down. Powering down may occur by an actual power down of the circuitry, and/or it may be turning off the clock signal, and/or it may be opening the switch 208. Accordingly, the modulator 210 may dissipate power at a lower rate, if at all, when there is no data to be transmitted. In certain instances when the clock signal is controlled or actual power down is used to reduce power dissipation, the switch 208 may not be needed.

The modulated signal from the modulator 210 may be communicated to the interpolator 212. The interpolator 212 may process the modulated signal. The processing may comprise digitally filtering the input signal to attenuate unwanted signal components. The processed signal may be communicated to the DAC 214, which may convert the processed signal to an analog signal. The analog signal may be communicated to the power amplifier 216. The output of the power amplifier 216 may be communicated to the antenna 218. The power amplifier 216 may have its amplifying gain controlled by input signals. For example, the gain of the power amplifier 216 may be controlled by the output of the DAC 222. An input of the DAC 222 may be derived from an output of the buffer 220. The buffer 220 may store ramp-up and ramp-down data for the power amplifier 216.

FIG. 2b is a block diagram of exemplary buffer for storing access burst data and normal burst data, in accordance with an embodiment of the invention. Referring to FIG. 2b, there is shown the buffer 204 and the multiplexer 206. The buffer 204 and the multiplexer 206 may be as described with respect to FIG. 2a.

The buffer 204 may comprise storage locations 204a, 204b, 204c, 204d, . . . , 204e. The storage locations 204a, 204b, 204c 204d, . . . , 204e may each store data for a particular burst. For example, the multiburst 25 (FIG. 1c) may comprise two bursts, and the storage locations 204a and 204b may store data for normal data bursts, for example, the normal data bursts 11a and 11b (FIG. 1c). Accordingly, when the multiburst 25 comprising the data in the storage locations 204a and 204b is transmitted, the data from the respective storage locations 204a and 204b may be selected at appropriate times and communicated to the multiplexer 206.

Similarly, the multiburst 26 (FIG. 1c) may comprise two bursts, and the storage location 204a may store data for an access burst, for example, the access burst 12a (FIG. 1c), and the storage location 204b may store data for a normal burst, for example, the normal burst 12b (FIG. 1c). Accordingly, when the multiburst comprising the data in the storage location 204a and 204b is transmitted, the data from the respective storage locations 204a and 204b may be selected at appropriate times and communicated to the multiplexer 206. In this manner, bursts of different data types, for example, normal data burst and access burst, may be transmitted in a single GSM frame by a single user operated GSM device.

The capacity of each buffer locations 204a, 204b, 204c, 204d, . . . , 204e may be design and/or implementation dependent. Each buffer location 204a, 204b, 204c, 204d, . . . , 204e may store data, for example, 88 bits, for the access burst, or data, for example, 148 bits, for the normal data burst. For example, some embodiments of the invention may have the same buffer location size regardless of the data stored. Accordingly, the buffer location may be large enough to store the larger data size. In this manner, for example, the processor 106 (FIG. 1d) may load the appropriate data for the access burst 12a and the normal data burst 12b in a multiburst and the start and end addresses for accessing data in each buffer location may be constant.

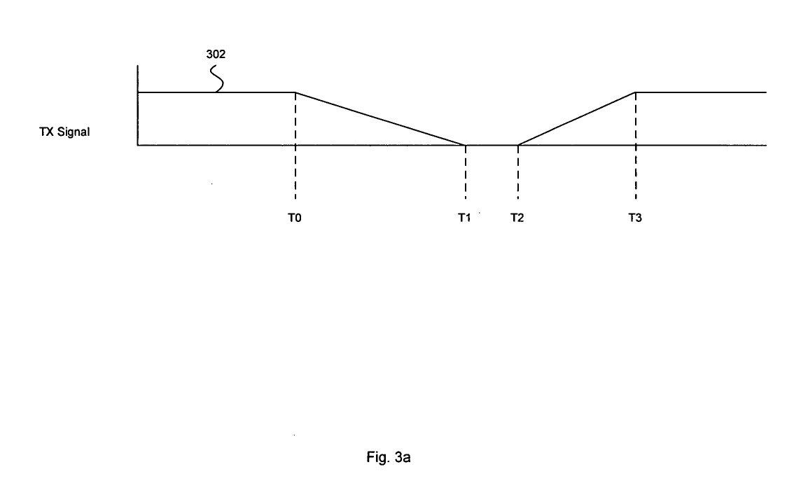

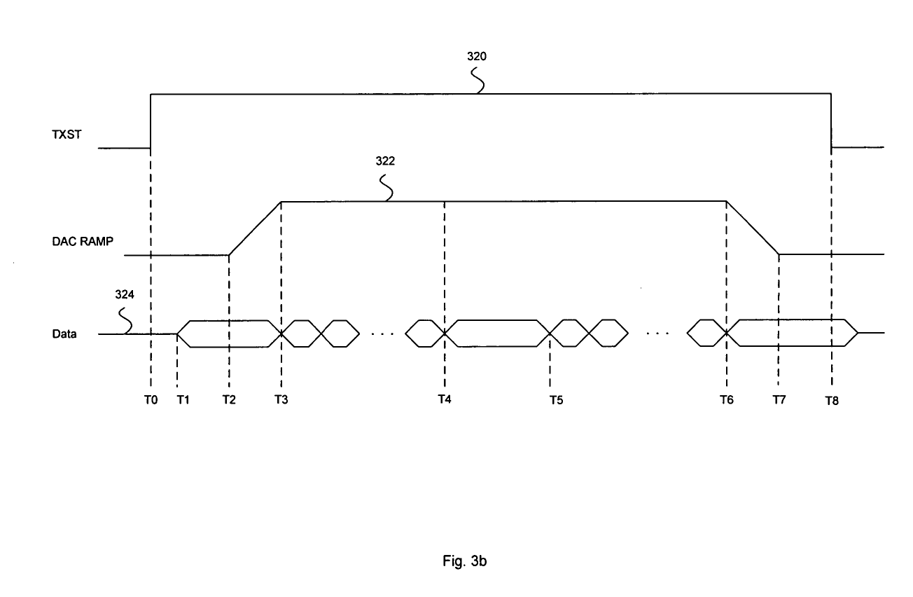

FIG. 3a is a timing diagram of power ramp-up and ramp-down during transmission, in accordance with an embodiment of the invention. Referring to FIG. 3a, there is shown a transmitted signal 302. At time instant T0, data that is to be transmitted may now have been completely transmitted and the transmitter power level may be ramped down once the transmission is complete. At time instant T1, the gain of the power amplifier 216 may be ramped down to a minimum level. At time instant T2, the power level of the power amplifier 216 may start to ramp-up for subsequent transmission of data. At time instant T3, the power level of the power amplifier 216 may be ramped up to a desired power level, and subsequent data may be transmitted. The duration of time periods from the time instant T0 to the time instant T1 and from the time instant T2 to the time instant T3 may be design and/or implementation dependent. When the amplifier power level is decreased to a minimum level, for example, during the period of time between the time instants T1 and T2, no power is utilized when there is no data to be transmitted.

FIG. 3b is a timing diagram of a multiburst transmission, in accordance with an embodiment of the invention. Referring to FIG. 3b, there is shown a transmit start signal 320, a GMSK ramp signal 322, and a data signal 324. The transmit start signal 320 may be asserted at time instant T0. This may allow generation of control signals for transmission of data. The time instants T1, T2, . . . , T8 may comprise delays with respect to the time instant T0. One embodiment of the invention may implement delays as multiples of a bit time during transmission, and multiples of ¼ bit time during power ramp-up and ramp-down periods. The period of time from the time instant T0 to the time instant T1 may be the time needed for the transmit path circuitry to power up. The DAC 214 (FIG. 2a) may be calibrated during the period of time from the time instant T0 to the time instant T3.

Calibration of the DAC 214 may comprise setting an output of the DAC 214 to a desired value given a reference input signal. Accordingly, the output of the DAC 214 may be accurate with respect to a reference. Calibration may be desirable for the DAC 214 because the output of the DAC 214 may be amplified by the power amplifier 216. Therefore, any inaccuracy in the output of the DAC 214 may be magnified by the amplification of the power amplifier 216.

A first burst may begin transmitting at time instant T1. For example, the time instant T1 may correspond to the start of the access burst 12a (FIG. 1c). An initialization portion of the burst, which may comprise logic ones, may be transmitted from the time instant T1 to the time instant T3. The time instant T2 may be when the power level starts to ramp up. At time instant T3, the desired power level may be reached, and the data portion of the burst may be transmitted. The data portion may comprise user data for the normal burst or system data for the access burst. The data portion of the first burst may be finished transmitting at time instant T4.

The second burst may transmit the initialization portion at time instant T4 and the data portion at time instant T5. For example, the time instant T4 may correspond to the start of the normal data burst 12b (FIG. 1c). When the second burst is finished transmitting at time instant T6, the power amplifier may be ramped down. The initialization signal comprising logic ones may be transmitted during this time. At time instant T7, the power amplifier may be ramped down, and at time instant T8 the transmit start signal 320 may be deasserted. Accordingly, an embodiment of the invention may allow GMSK modulated transmission of access burst and normal data burst in the same multiburst, where the bursts may be in the same frame.

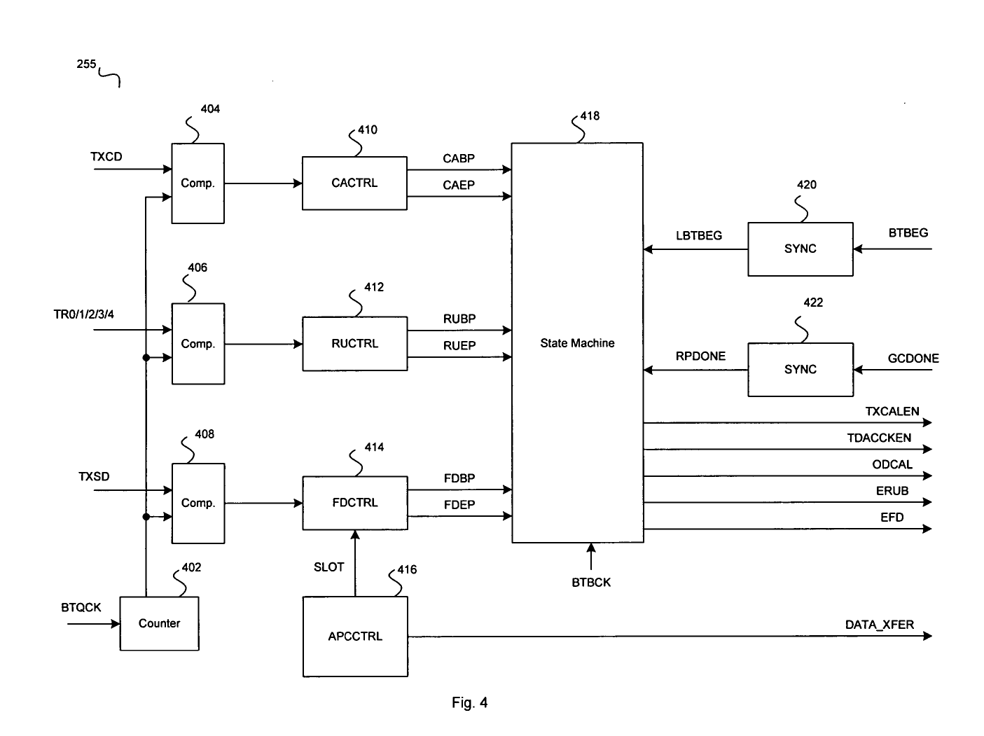

FIG. 4 is a block diagram illustrating exemplary event generator, in accordance with an embodiment of the invention. Referring to FIG. 4, there is shown the event generator 255 (FIG. 2a) that comprises a counter 402, compare blocks 404, 406, and 408, a calibration control block 410, a ramp-up control block 412, a data fetch block 414, an automatic power control (APC) block 416, a state machine 418, and synchronization blocks 420 and 422.

The counter 402 may comprise suitable logic and/or circuitry that may be adapted to count, for example, a 13-bit value. The number of bits counted by the counter 402 may be design and/or implementation dependent. The counter 402 may communicate the 13-bit output to other blocks, for example, the compare blocks 404, 406, and 408. The counter 402 may be utilized to effectively provide delay timing in the compare blocks 404, 406 and 408 with respect to each other that may be used to start and/or end various states. For example, it may be desirable to have the output of the compare block 404 asserted three clock cycles after the output of the compare block 406 is asserted. Accordingly, the value communicated to the compare block 404 may be larger by three than the value communicated to the compare block 406. Since the output of the counter 402 is communicated to both compare blocks 404 and 406, the output of the compare block 404 may be asserted three clock cycles after the output of the compare block 406.

The compare blocks 404, 406, and 408 may comprise suitable logic and/or circuitry that may be adapted to compare two inputs and assert an output signal when the two inputs are equal. For example, the compare block 404 may have as inputs TXCD and the output of the counter 402. The calibration control block 410 may comprise suitable logic and/or circuitry that may be adapted to indicate start and end of a calibration period based on an input signal. The calibration period may be, for example, the period from the time instant T0 (FIG. 3b ) to the time instant T1 (FIG. 3b ) when a DAC, for example, the DAC 214 (FIG. 2a), may have its output calibrated to a desired value given a known input value. The ramp-up control block 412 may comprise suitable logic and/or circuitry that may be adapted to indicate start and end of a ramp up and ramp down periods based on an input signal. The data fetch block 414 may comprise suitable logic and/or circuitry that may be adapted to indicate when data may be transferred based on an input signal SLOT. The input signal SLOT may be generated by the APC block 416.

The APC block 416 may comprise suitable logic and/or circuitry that may be adapted to generate control signals that may be communicated to, for example, the switch 208 (FIG. 2a). The control signals may indicate to the switch 208 whether to close to transfer data from the multiplexer 206 to the interpolator 210.

The state machine 418 may comprise suitable logic and/or circuitry that may be adapted to generate control and/or state outputs that may be utilized in transmission of data for access burst and normal data burst. The synchronization blocks 420 and 422 may comprise suitable logic and/or circuitry that may be adapted to receive input signals and synchronize them with respect to a clock used by another block. For example, the clock signal BTBCK used by the state machine 418 may be used by the synchronization blocks 420 and 422.

In operation, the counter 402 may be, for example, a 13-bit free running counter that may be clocked by a clock signal BTQCK. The clock signal BTQCK may be a quarter-bit period clock that may be active during data transmission period. The counter 402 may communicate the 13-bit count to each of the compare blocks 404, 406, and 408. Each of the compare blocks 404, 406, and 408 may compare the 13-bit value from the counter 402 to its respective input TXCD, TR0/1/2/3/4, or TXSD. Each compare block 404, 406, and 408 may assert an output signal when its respective inputs are equal to each other. For example, the compare block 404 may assert its output signal when the value of the signal TXCD is equal to the 13-bit value from the counter 402. The outputs of the compare blocks 404, 406, and 408 may be communicated to the calibration control block 410, the ramp-up control block 412, and the data fetch block 414, respectively. The control blocks 410, 412, and 414 may indicate the start and end of a period with respect to its input signal.

For example, the calibration control block 410 may output a calibration begin pulse signal CABP at an appropriate time to allow calibration of, for example, the DAC 214 (FIG. 2a), at or after the time instant T0 (FIG. 3b ). The calibration control block 410 may output a calibration end pulse signal CAEP at an appropriate time to allow data transmission to occur, for example, at time instant T1 (FIG. 3b ). The appropriate time may be design and/or implementation dependent. Similarly, the ramp-up control block 412 may output a begin ramp-up pulse signal RUBP that may indicate start of ramp-up and/or ramp-down period and an end ramp-up pulse signal RUEP that may indicate end of ramp-up and/or ramp-down period. The fetch data begin pulse signal FDBP from the data fetch control block 414 may indicate start of a period when new data can be fetched for transmission. The fetch data end pulse signal FDEP from the data fetch control block 414 may indicate end of the period when new data can be fetched for transmission.

The state machine 418 may receive inputs from the calibration control block 410, the ramp-up control block 412, the data fetch block 414, as well as synchronized baseband transmit begin signal LBTBEG from the SYNC block 420 and synchronized ramp-up/ramp-down done signal RPDONE from the SYNC block 422. The state machine 418 may generate outputs, for example, a transmit calibration enable signal TXCALEN, a transmit DAC clock enable signal TDACCKEN, a ramp-up/ramp-down signal ERUB, and an enable fetch data signal EFD.

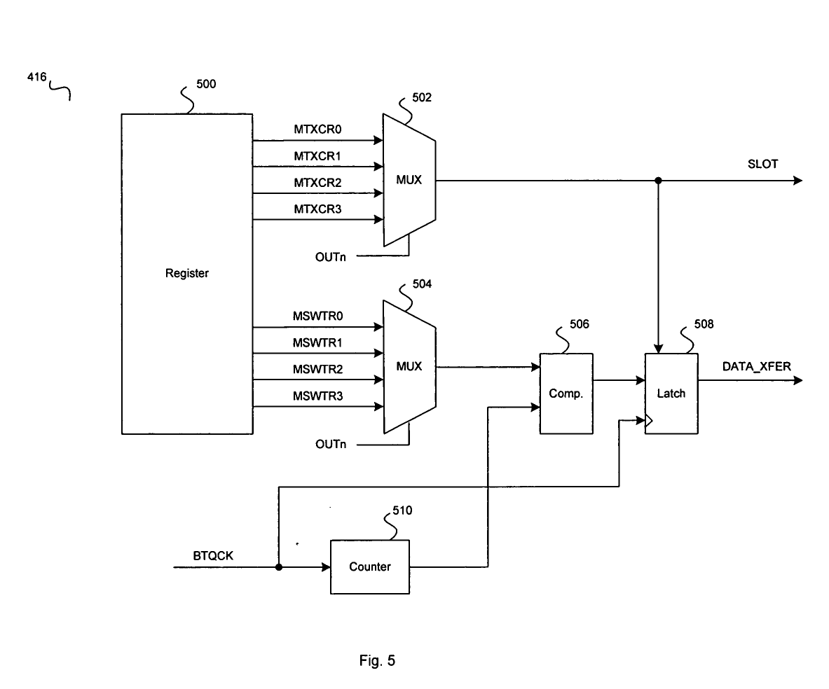

The APC block 416, which is described in more detail in FIG. 5, may generate a signal SLOT that may indicate to the data fetch control block 414 when a burst may start for transmission of data. The APC block 416 may also generate signals that may be utilized to control multiplexers and/or switches, such as, for example, the multiplexer 206 and the switch 208. A generated signal, for example, DATA_XFER, may be used, for example, to control the switch 208 (FIG. 2a).

FIG. 5 is a block diagram illustrating an automatic power control block, in accordance with an embodiment of the invention. Referring to FIG. 5, there is shown the APC block 416 that comprises a register block 500, multiplexers 502 and 504, a compare block 506, a latch 508, and a counter 510.

Data may be written by a processor, for example, the processor 106 (FIG. 1d), or by hardware, for example, the control logic 250 (FIG. 2a), that may transfer data from a memory, for example, the memory block 108 (FIG. 1d). The multiplexer 502 may receive inputs from the register block 500, and the output of the multiplexer 502 may be the control signal SLOT. The control signal SLOT may be asserted for the duration in which there may be normal data burst and/or access burst transmission. The control signal SLOT may be communicated to the data fetch control block 414 (FIG. 4) and to the latch 508. The multiplexer 504 may receive inputs from the register block 500, and the output of the multiplexer 504 may be communicated to the compare block 506. The output of the compare block 506 may be communicated to a latch 508. The latch 508 may latch the output of the compare block 506 utilizing a clock signal, for example, the clock signal BTQCK, that may be the same clock signal used by the counter 510, when the latch 508 is enabled by the control signal SLOT from the multiplexer 502. The counter 510 may be clocked by the clock BTQCK and may communicate its count value to the compare block 506.

In operation, the multiplexers 502 and 504 may each receive four inputs from the register block 500. Each input to the multiplexers 502 and 504 may correspond to a burst, which may be the access burst or the normal burst, that may be transmitted in a multiburst transmission. The stored data in the register block 500 may be communicated to the multiplexers 502 and 504. The multiplexers 502 and 504 may utilize at least one control signal, for example, the signal OUTn from the control logic 250 (FIG. 2a), to select an input to transfer to the output. The control signal SLOT of the multiplexer 502 may be communicated to the data fetch control block 414 and to the latch 508. The control signal SLOT may be utilized to enable the latch 508.

The compare block 506 may assert its output signal when the count value communicated by the counter 510 is the same as the value of the of the output signal communicated by the multiplexer 504. The output signal of the compare block 506 may be latched by the latch 508 utilizing the clock signal BTQCK. The control signal SLOT may enable the latch 508.

Accordingly, in one exemplary embodiment of the invention as shown in FIG. 5 may have up to four bursts in a multiburst. However, the invention need not be limited in this manner. Other embodiments of the invention may allow transmission of a multiple number of bursts other than four. The multiplexer 502 may receive a control signal generated by, for example, the control logic 250 (FIG. 2a), that may indicate which input to transfer to the output.

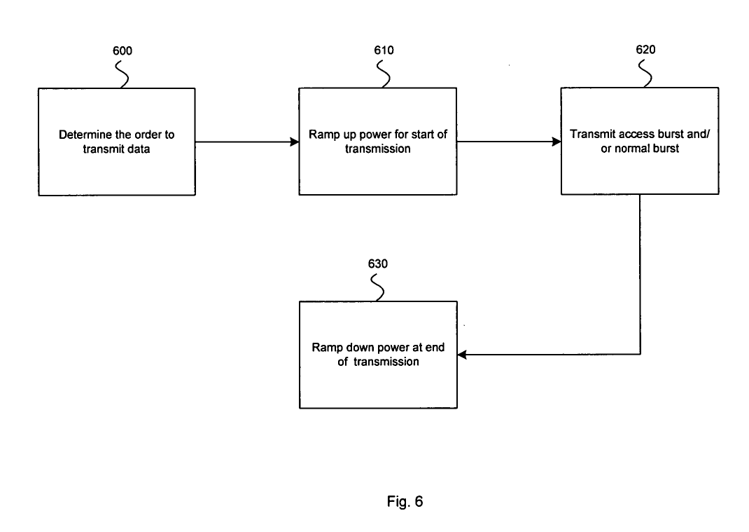

FIG. 6 is a flow diagram illustrating exemplary routine for access burst and normal burst mix-mode support, in accordance with an embodiment of the invention. In step 600, preparations may be made for a multiburst transmission of normal burst and/or access burst in a multiburst. In step 610, power may be ramped up for the transmission. In step 620, the burst information may be amplified and transmitted. In step 630, the power may be ramped down after data transmission.

Referring to FIG. 6, and with respect to FIGS. 1, 2, 4, and 5, there is shown a plurality of steps 600 to 630 that may be utilized to support access burst and/or normal burst transmissions. In step 600, a buffer and/or a register, for example, the data buffer 204 and the register block 500, respectively, may be loaded with data by, for example, the processor 106. The data in the data buffer 204 may comprise access burst data and/or normal burst data that may be transmitted in a multiburst. The data in the register block 500 may comprise information regarding specific bursts in the multiburst. For example, the information may comprise an indication of specific slots that may be used in the multiburst.

In step 610, appropriate power control may be executed for the burst modulation. For example, the power amplifier 216 may be adjusted to ramp up to a desired output power such that signals may be transmitted by the antenna 218 at the correct power level. This may be accomplished by using data in the buffer 220. In step 620, the data from the buffers 202 and 204 may be communicated to the modulator 210 via the multiplexer 206 and the switch 208. An output signal of the modulator 210 may be transferred to the interpolator 212. The transferred signal may be processed by the interpolator 212, the DAC 214, and amplified by the power amplifier 216 before being transmitted by the antenna 218. In step 630, the multiburst may be finished, and, accordingly, appropriate power control may be executed to ramp-down the power level of the power amplifier 216. Output of data from the buffers 204, 228, 230, and 232 may be controlled by control signals from, for example, the control logic 250 and/or the state machine 418.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for transmitting data, the method comprising transmitting bursts of different data types within a single GSM frame by a single GSM device, wherein said different data types comprise access burst data type and normal burst data type.

2. The method according to claim 1, further comprising ramping up transmit power prior to said transmitting a first burst in said GSM frame by said single GSM device.

3. The method according to claim 2, further comprising storing a plurality of ramp-up values for use in said ramping up transmit power.

4. The method according to claim 3, further comprising converting said plurality of ramp-up values to an analog control signal to control said ramping up transmit power.

5. The method according to claim 1, further comprising ramping down transmit power after said transmitting a last burst in said GSM frame for said single GSM device.

6. The method according to claim 5, further comprising storing a plurality of ramp-down values for use in said ramping down transmit power.

7. The method according to claim 6, further comprising converting said plurality of ramp-down values to an analog control signal to control said ramping down transmit power.

8. The method according to claim 1, further comprising storing data in memory to be transmitted within said single GSM frame by a single GSM device.

9. The method according to claim 8, further comprising selecting at least a portion of said stored data for initialization portion of said bursts.

10. The method according to claim 8, further comprising selecting at least a portion of said stored data for data portion of said bursts.

11. A system for transmitting data, the system comprising circuitry that transmits bursts of different data types within a single GSM frame by a single GSM device, wherein said different data types comprise access burst data type and normal burst data type.

12. The system according to claim 11, further comprising circuitry that ramps up transmit power prior to said transmitting a first burst in said GSM frame by said single GSM device.

13. The system according to claim 12, further comprising circuitry that stores a plurality of ramp-up values for use in said ramping up transmit power.

14. The system according to claim 13, further comprising circuitry that converts said plurality of ramp-up values to an analog control signal that is used to indicate said ramping up transmit power.

15. The system according to claim 11, further comprising circuitry that ramps down transmit power after said transmitting a last burst in said GSM frame by said single GSM device.

16. The system according to claim 15, further comprising circuitry that stores a plurality of ramp-down values for use in said ramping down transmit power.

17. The system according to claim 16, further comprising circuitry that converts said plurality of ramp-down values to an analog control signal to control said ramping down transmit power.

18. The system according to claim 11, further comprising circuitry that stores data in memory, wherein said data is transmitted within said single GSM frame by said single GSM device.

19. The system according to claim 19, further comprising circuitry that selects at least a portion of said stored data for initialization portion of said bursts.

20. The system according to claim 19, further comprising circuitry that selects at least a portion of said stored data for data portion of said bursts.
